(19) United States
(12) Patent Application Publication
(10) Pub. No.: US 2008/0248776 A1
(43) Pub. Date: Oct. 9, 2008

(54) High-frequency circuit

(76) Inventors: Seiichi Banba, Ogaki-shi (JP); Kohji Sakata, Ichinomiya-shi (JP)

Correspondence Address: MCDERMOTT WILL & EMERY LLP, 600 13TH STREET, N.W., WASHINGTON, DC, 20005-3096, US

(21) Appl. No.: 12/078,319

(22) Filed: Mar. 28, 2008

(30) Foreign Application Priority Data
Mar. 30, 2007 (JP) 2007-093418
Mar. 7, 2008 (JP) 2008-058726

(51) Int. Cl. H04B 1/26

(52) U.S. Cl. 455/327

(57) ABSTRACT

A mixer circuit receives a local signal and an input signal so as to output a high-frequency signal generated based on the received signals. An output buffer receives the high-frequency signal. A band-pass filter having predetermined characteristics is formed by using the parameters of passive elements included in an output equivalent circuit as viewed from an output terminal of the mixer circuit and the parameters of passive elements included in an input equivalent circuit as viewed from an input terminal of the output buffer circuit.

### CROSS-REFERENCE TO RELATED APPLICATIONS

This application is based upon and claims the benefit of priority from the prior Japanese Patent Applications No. 2007-093418, filed Mar. 30, 2007, and Japanese Patent Application No. 2008-058726, filed Mar. 7, 2008, the entire contents of which are incorporated herein by reference.

### BACKGROUND OF THE INVENTION

1. Field of the Invention

The present invention relates to high-frequency circuits used in, for example, a transmission circuit operated in the GHz frequency band.

2. Description of the Related Art

A transmission circuit operated in the GHz frequency band (in particularly, a transmission mixer) is designed to have a certain conversion gain at a desired frequency or frequency band. It is desirable, however, that the gain be small at the other frequencies for the purpose of preventing undesired radio signals from being generated in the transmission circuit. This is generally addressed by attaching a resonator circuit operative to increase the gain around the desired frequency to the load of the transmission mixer so as to limit the band.

Meanwhile, in a communication scheme such as Ultra Wide Band (UWB) which uses an extremely wide band, an external filter element may be provided in order to provide a flat gain over a wide band and reduce the gain outside the band.

### SUMMARY OF THE INVENTION

A high frequency circuit according to one aspect of the present invention comprises a mixer circuit which receives a local signal and an input signal so as to output a high-frequency signal generated based on those signals, and an output buffer circuit which receives the high-frequency signal. A band-pass filter having predetermined characteristics is formed by using the parameters of passive elements included in an output equivalent circuit as viewed from an output terminal of the mixer circuit and the parameters of passive elements included in an input equivalent circuit as viewed from an input terminal of the output buffer circuit.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the circuit configuration of a second-order Butterworth BPF used in an embodiment of the present invention;

FIG. 2A shows the reflection characteristic of the second-order Butterworth BPF;

FIG. 2B shows the pass characteristic of the second-order Butterworth BPF;

FIG. 3A shows the circuit configuration of an output buffer according to the embodiment;

FIG. 3B shows an equivalent circuit of the output buffer according to the embodiment;

FIGS. 4A-4C are charts showing examples of extracting the input equivalent circuit of the common-drain FET provided with a feedback circuit;

FIG. 4A shows a case where the feedback capacitor Cf=0 pF and there is no feedback circuit;

FIG. 4B shows a case where the feedback capacitor Cf=0.5 pF and the feedback resistor Rf=50Ω;

FIG. 4C shows a case where the feedback capacitor Cf=0.5 pF and the feedback resistor Rf=100Ω;

FIG. 5 shows the equivalent circuit as viewed from a mixer output terminal;

FIG. 6 shows the overall configuration of a transmission mixer circuit according to the embodiment;

FIG. 7 is a diagram illustrating the principle for explaining the frequency characteristic of conversion gain of the transmission mixer circuit according to the embodiment;

FIGS. 8A and 8B show the frequency characteristic of conversion gain;

FIG. 8A shows a case where the input resistor RM=50Ω;

FIG. 8B shows a case where the input resistor RM=200Ω;

FIG. 9 shows the overall configuration of a transmission mixer according to the first exemplary embodiment;

FIGS. 10A and 10B are graphs plotting circuit parameters of an input equivalent circuit of a common-drain FET provided with a feedback circuit;

FIG. 10A shows the dependence of an input resistance Rin on a feedback capacitance Cf and a feedback resistance Rf;

FIG. 10B shows the dependence of an input capacitance Cin on the feedback capacitance Cf and the feedback resistance Rf;

FIG. 11 shows the frequency characteristic of the transmission mixer circuit according to the first exemplary embodiment;

FIG. 12 shows the frequency characteristic of a transmission mixer circuit according to the second exemplary embodiment;

FIG. 13 shows the circuit configuration of an output buffer according to the third exemplary embodiment;

FIG. 14 shows the frequency characteristic of a transmission mixer circuit according to the third exemplary embodiment;

FIG. 15 shows the frequency characteristic of a transmission mixer circuit according to the fourth exemplary embodiment; and

FIG. 16 shows the overall configuration of a transmission mixer circuit according to a variation of the first exemplary embodiment.

### DETAILED DESCRIPTION OF THE INVENTION

The invention will now be described by reference to the preferred embodiments. This does not intend to limit the scope of the present invention, but to exemplify the invention.

A description will now be given of representative modes of an embodiment of the present invention before explaining the embodiment in detail. A high frequency circuit according to one aspect of the present invention comprises a mixer circuit which receives a local signal and an input signal so as to output a high-frequency signal generated based on those signals, and an output buffer circuit which receives the high-frequency signal. A band-pass filter having predetermined characteristics is formed by using the parameters of passive elements included in an output equivalent circuit as viewed from an output terminal of the mixer circuit and the parameters of passive elements included in an input equivalent circuit as viewed from an input terminal of the output buffer circuit.

According to this embodiment, since the circuit is provided with the mixer circuit and the output buffer circuit having the characteristics of a band-pass filter, a flat gain is obtained over a wide band without requiring a filter element and without increasing the circuit scale.

The circuit may also be provided with an interstage inductor coupled between the output terminal and the input terminal. The mixer circuit may comprise a first common-source transistor receiving the input signal at its gate terminal, a second common-source transistor connected to the drain terminal of the first common-source transistor and receiving the local signal at its gate terminal, and an resonator load connected to the drain terminal of the second common-source transistor and including a parallel circuit in which a mixer load inductor and a mixer load capacitor are connected in parallel. The mixer circuit may output the high-frequency signal from the drain terminal (i.e., the output terminal) of the second common-source transistor. The output buffer circuit may comprise a common-drain transistor receiving the high-frequency signal at its gate terminal (i.e., the input terminal) and outputting a signal corresponding to the high-frequency signal from its source terminal, and an adjustment circuit inserted between the gate terminal and the drain terminal of the common-drain transistor and including a series circuit in which an adjustment resistor and an adjustment capacitor are connected in series. The “adjustment circuit” may be inserted between the drain terminal of the common-drain transistor and an ac-grounded terminal. “Source terminal” may be interpreted as “emitter terminal”, “gate terminal” as “base terminal”, and “drain terminal” as “collector terminal”. The “input signal”, “local signal”, or “high-frequency signal” may be input as a current to the “base terminal”. According to the aforementioned mode, a second-order Butterworth band-pass filter is formed.

The input equivalent circuit representing the input impedance of the common-drain transistor may be approximated by a series circuit in which an input resistor and an input capacitor are connected in series. A first internal equivalent resistor of the common-drain transistor and a second internal equivalent resistor as viewed from the drain terminal of the second common-source transistor represent reference resistors at the respective ends of the band-pass filter. The band-pass filter may be formed by using a first internal equivalent capacitor of the second common-source transistor, a second internal equivalent capacitor of the common-drain transistor, the mixer load inductor, the interstage inductor, and the mixer load capacitor.

The circuit may also be provided with a local amplifier circuit operative to generate the local signal by amplifying a given signal and output the local signal to the mixer circuit. The local amplifier circuit may be provided with an inductive load including a series circuit in which a amplifier stage load inductor and an amplifier stage load resistor are connected in series. According to this aspect, the frequency characteristic of conversion gain can be adjusted.

The circuit may also be provided with an interstage inductor coupled between the output terminal and the input terminal. The mixer circuit may comprise a first common-source transistor receiving the input signal at its gate terminal, a second common-source transistor connected to the drain terminal of the first common-source transistor and receiving the local signal at its gate terminal, and an oscillator load connected to the drain terminal of the second common-source transistor and including a parallel circuit in which a mixer load inductor and a mixer load capacitor are connected in parallel. The mixer circuit may output the high-frequency signal from the drain terminal (i.e., the output terminal) of the second common-source transistor. The output buffer circuit may comprise a third common-source transistor receiving the high-frequency signal at its gate terminal (i.e., the input terminal), a common-gate transistor connected to the drain terminal of the third common-source transistor, an inductive load connected to the drain terminal of the common-gate transistor and including a series circuit in which an output stage load inductor and an output stage load resistor are connected in series, a source inductor inserted between the source terminal of the third common-source transistor and a given fixed potential, and a gate-source capacitor inserted between the gate terminal and the source terminal of the third common-source transistor. According to this aspect, a high conversion gain can be obtained in a predetermined band.

The resonator load may include a parallel circuit in which a mixer load inductor, a mixer load resistor, and a mixer load capacitor are connected in parallel. According to this aspect, the frequency characteristic of conversion gain can be adjusted.

Another aspect of the present invention also relates to a high-frequency circuit. The high-frequency circuit comprises a common-drain transistor receiving a high-frequency signal at its gate terminal and outputting a signal corresponding to the high-frequency signal from its source terminal, and an adjustment circuit inserted between the gate terminal and the drain terminal of the common-drain transistor and including a series circuit in which an adjustment resistor and an adjustment capacitor are connected in series. The input impedance of the common-drain transistor is adjusted by at least one of the adjustment resistor and the adjustment capacitor as a parameter. The “adjustment circuit” may be inserted between the gate terminal of the common-drain transistor and an ac-grounded terminal.

According to this aspect, it is possible to generate, responsive to an input high-frequency signal, an output signal having a flat characteristic over a wide band without increasing the circuit scale.

The adjustment resistor and the adjustment capacitor as parameters may be set such that the internal resistance and the internal capacitance defined by the input impedance of the common-drain transistor represent the circuit parameters of a desired band-pass filter.

Optional combinations of the aforementioned constituting elements, and implementations of the invention in the form of methods, apparatuses, systems, and the like may also be practiced as additional modes of the present invention.

A description will be given, with reference to the drawings, of the preferred embodiment of the present invention. Like numerals in the figures represent like constituting elements, member, and processes, and the repeated description thereof is omitted as appropriate. Reference herein to details of the illustrated embodiment is not intended to limit the scope of the claims. It should be understood that not all of the features and the combination thereof discussed are essential to the invention.

A description will now be given of an outline of a wideband transmission mixer circuit according to an embodiment. The wideband transmission mixer circuit according to the embodiment is suitable for silicon radio frequency integrated circuits (RFIC) and is provided with a Gilbert mixer, a common-drain field effect transistor (FET) (hereinafter, referred to as a CDF) as a mixer output buffer, and a local buffer amplifier. More specifically, a wideband transmission circuit is produced by providing a band-pass filter (BPF) having a desired bandwidth between the mixer load and the mixer output buffer.

Firstly, a series adjustment circuit comprising an adjustment resistor and an adjustment capacitor is provided between the drain and the gate of the common-drain FET. With this, the input equivalent circuit of the common-drain FET can be viewed as a series circuit comprising a desired resistor and capacitor. As discussed later, the adjustment circuit may not necessarily be configured to form a feedback path. Hereinafter, however, the circuit configuration not provided with a feedback path may also be referred to as a feedback circuit for convenience as the description will focus on the circuit configuration provided with a feedback path. Similarly, an adjustment resistor will be referred to as a feedback resistor and an adjustment capacitor will be referred to as a feedback capacitor.

The RF signal output terminal of the Gilbert mixer is the drain terminal of the FET forming the mixer. The FET can be approximated by a parallel circuit comprising a resistor and a capacitor. It is ensured, secondly, that the internal equivalent circuit plus the inventive circuit produce the BPF characteristic having a desired band. That is, a parallel circuit comprising a resistor, a capacitor, and an inductor is provided between the RF signal output terminal of the mixer and a power supply. The BPF characteristic is produced by additionally providing an inductor between the RF signal output terminal and the mixer output buffer. Thirdly, by adjusting a load circuit of the local buffer amplifier, flatness over the band is produced.

A description will now be given of the operating principle of the wideband transmission mixer circuit according to the embodiment.

The method of configuring the BPF will be explained first (I).

The central frequency, the bandwidth, and the order are important design parameters of the BPF formulated by lumped-parameter elements L and C. To be more specific, filter types (Butterworth, Chebyshev, etc.) are determined according to their pass characteristic. The values of the inductance L and the capacitance C are determined in association with the respective filter types.

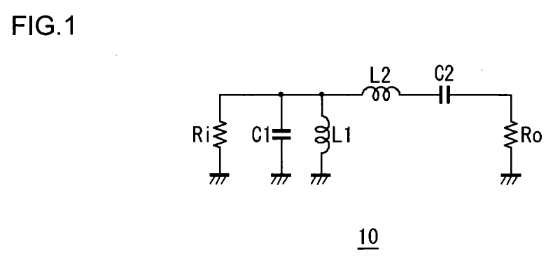

FIG. 1 shows the circuit configuration of a second-order Butterworth BPF 10 used in the embodiment. The second-order Butterworth BPF 10 includes a series circuit inserted between an input resistor Ri and an output resistor Ro. The series circuit comprises a second inductance L2 and a second capacitor C2. A first capacitor C1 and a first inductor L1 are inserted in parallel between the ground and a node between the input resistor Ri and the second inductor L2.

The input resistor Ri and the output resistor Ro represent reference impedances. Generally, the resistor and the capacitor are set to 50Ω. The values of the first inductor L1, the first capacitor C1, the second inductor L2, and the second capacitor C2 are given by the expression (1) below, where ωL denotes a lower cut-off frequency, ωH denotes a higher cut-off frequency, ωBW denotes a bandwidth, and ωC denotes a central frequency, represented in angular frequencies.

$${L}_{1} = \frac{{kR}_{O}}{{ω}_{BW}} , \\ {C}_{1} = \frac{{ω}_{BW}}{k {ω}_{C}^{2} {R}_{O}} , \\ {L}_{2} = \frac{{ω}_{BW} {R}_{O}}{k {ω}_{C}^{2}} , \\ {C}_{2} = \frac{k}{{ω}_{BW} {R}_{O}} \\ ∵ k = \sqrt{2} , {ω}_{C} = \sqrt{{ω}_{L} \cdot {ω}_{H}} , {ω}_{BW} = {ω}_{H} - {ω}_{L} \qquad ( 1 )$$

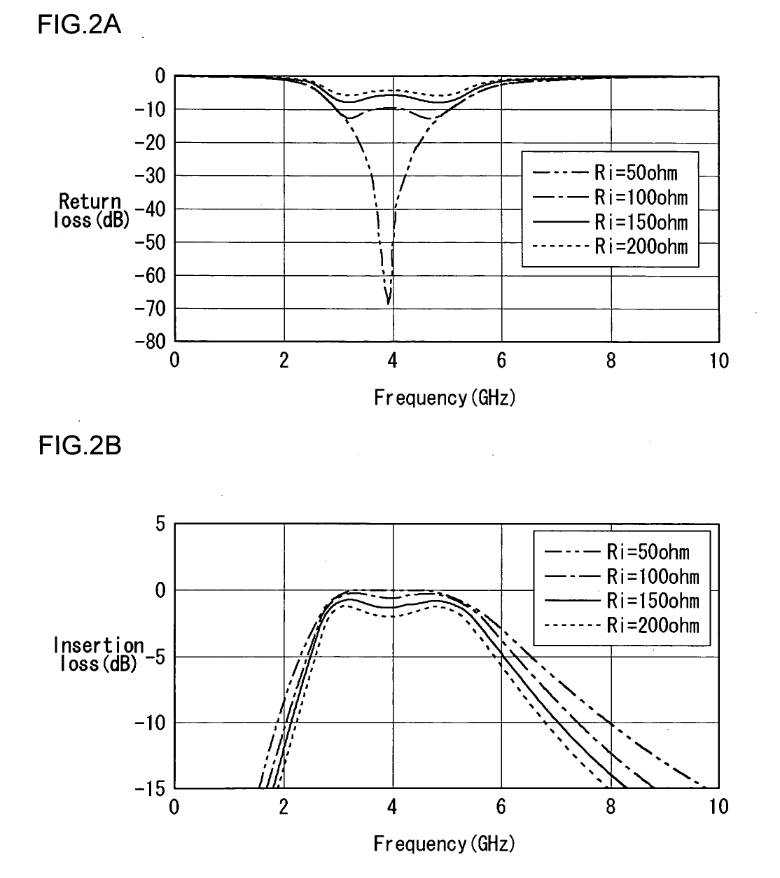

FIGS. 2A and 2B show the frequency characteristic of the second-order Butterworth BPF 10. FIG. 2A shows the reflection characteristic of the second-order Butterworth BPF 10, and FIG. 2B shows the pass characteristic of the second-order Butterworth BPF 10. By way of example, the lower cut-off frequency ωL is set to be 2.5 GHz, and the higher cut-off frequency ωH is set to be 6 GHz. In this example, the first inductor L1=1.313 nH, the first capacitor C1=1.286 pF, the second inductor L2=3.215 nH, and the second capacitor C2=0.525 pF. Referring to FIG. 2, one of the reference impedances is fixed at 50Ω, and the other reference impedance is varied such that it is 50, 100, 150, or 200Ω. By varying one of the reference impedances, the transmission characteristic having a minimum value at the central frequency is produced.

As explained above, by forming the BPF circuit as shown in FIG. 1 between the Gilbert mixer and the mixer output buffer, a transmission circuit capable of operating in a desired band is produced. The output resistor Ro may not be 50Ω. The reference impedances at the respective ends may be different.

A description will now be given of the input equivalent circuit of the mixer output buffer (II). Generally, the mixer is followed by a buffer circuit formed by a common-drain FET having its drain terminal ac-grounded. In the inventive approach, a feedback circuit comprising a feedback resistor Rf and a feedback capacitor Cf connected in series is provided between the gate and the drain of the CDF. It will be appreciated that, by adjusting these values, the input equivalent circuit of the CDF is represented by a series circuit in which a resistor and a capacitor are connected in series.

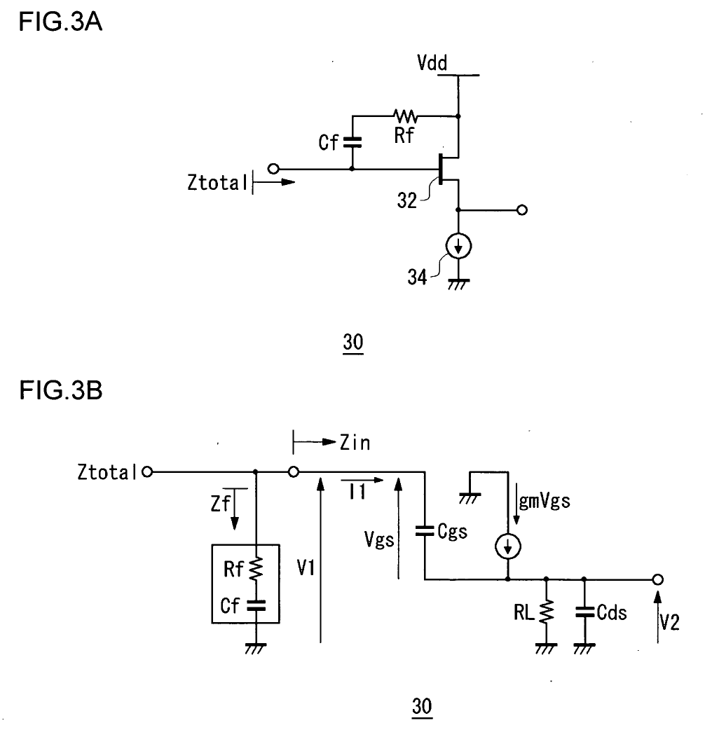

FIGS. 3A and 3B show the principle for determining the input impedance of the common-drain FET provided with a feedback circuit. FIG. 3A shows the circuit configuration of an output buffer 30 according to the embodiment. The output buffer 30 is provided with a common-drain FET 32, a constant-current source 34, and a feedback circuit. The common-drain FET 32 is formed by an n-channel metal oxide semiconductor field effect transistor (MOSFET). Hereinafter, it will be assumed that an FET is formed by an nMOSFET unless otherwise specified.

The drain terminal of the common-drain FET 32 is connected to a power supply, and the source terminal is connected to the constant-current source 34 having one end thereof connected to the ground. The common-drain FET 32 receives an input signal at its gate terminal and outputs a signal from its source terminal. A feedback circuit comprising a feedback resistor Rf and a feedback capacitor Cf connected in series is connected between the gate and the drain.

FIG. 3B shows an equivalent circuit of the output buffer 30 according to the embodiment. The input impedance of the output buffer 30 loaded with a feedback circuit will be determined. The input impedance Zin of the common-drain FET 32 taken alone will be determined, taking into consideration a gate-source parasitic capacitance Cgs and a drain-source parasitic capacitance Cds, which largely affect the impedance in the high-frequency band. Thereafter, the combined impedance Ztotal comprising the input impedance Zin and the impedance Zf of the feedback circuit will be determined.

The circuit equation for determining the input impedance Zin of the common-drain FET 32 taken alone is the expression (2) below.

$${Z}_{IN} = \frac{{V}_{1}}{{I}_{1}} \\ {V}_{1} = {V}_{gs} + {V}_{2} \\ {V}_{2} = ( {I}_{1} + {g}_{m} {V}_{gs} ) {Z}_{2} \\ {V}_{gs} = {Z}_{1} {I}_{1} \\ ∵ {Z}_{1} = \frac{1}{jω {C}_{gs}} , {Z}_{2} = \frac{1}{\frac{1}{{R}_{L}} + jω {C}_{ds}} = \frac{{R}_{L}}{1 + jω {C}_{ds} {R}_{L}} \qquad ( 2 )$$

Solving the expression (2), the input impedance Zin of the common-drain FET 32 taken alone is given by the expression (3) below.

$${Z}_{IN} = Re ( {Z}_{IN} ) + j Im ( {Z}_{IN} ) \\ Re ( {Z}_{IN} ) = \frac{{R}_{L}}{1 + {( ω {C}_{ds} {R}_{L} )}^{2}} - \frac{{ω}^{2} {C}_{ds} {C}_{gs} {R}_{L}^{2} {g}_{m}}{{( {ω}^{2} {C}_{ds} {C}_{gs} {R}_{L} )}^{2} + {( ω {C}_{gs} )}^{2}} \\ Im ( {Z}_{IN} ) = - ( \frac{1}{ω {C}_{gs}} + \frac{ω {C}_{gs} {g}_{m} {R}_{L}}{\begin{matrix}{( {ω}^{2} {C}_{ds} {C}_{gs} {R}_{L} )}^{2} + \\ {( ω {C}_{gs} )}^{2}\end{matrix}} + \frac{ω {C}_{ds} {R}_{L}^{2}}{1 + {( ω {C}_{ds} {R}_{L} )}^{2}} ) \qquad ( 3 )$$

The drain-source parasitic capacitance Cds is on the order of 100-1000 fF, and the load resistance RL is on the order of 10-100Ω. Assuming a GHz-band frequency, approximation as shown in the expression (4) below is valid. Thus, the input impedance Zin can be represented in a simplified manner.

$${( ω {C}_{ds} {R}_{L} )}^{2} ≪ 1 \\ {Z}_{IN} \approx {R}_{L} ( 1 - \frac{{C}_{ds} {R}_{L} {g}_{m}}{{C}_{gs}} ) - j ( \frac{1 + {g}_{m} {R}_{L}}{ω {C}_{gs}} + ω {C}_{ds} {R}_{L}^{2} ) \qquad ( 4 )$$

Finally, the combined impedance Ztotal comprising the input impedance Zin of the common-drain FET 32 taken alone and the impedance Zf of the feedback circuit is given by the expression (5) below.

$${Z}_{f} = {R}_{f} - j \frac{1}{ω {C}_{f}} ≡ A - j B \\ {Z}_{IN} \approx {R}_{L} ( 1 - \frac{{C}_{ds} {R}_{L} {g}_{m}}{{C}_{gs}} ) - j ( \begin{matrix}\frac{1 + {g}_{m} {R}_{L}}{ω {C}_{gs}} + \\ ω {C}_{ds} {R}_{L}^{2}\end{matrix} ) ≡ C - j D \\ \begin{matrix}{Z}_{total} = \frac{{Z}_{f} \cdot {Z}_{IN}}{{Z}_{f} + {Z}_{IN}} \\ = \frac{( A - j B ) ( C - j D )}{A - j B + C - j D} \\ = \frac{A C ( A + C ) + {B}^{2} C + {AD}^{2}}{{( A + C )}^{2} + {( B + D )}^{2}} - j \frac{BD ( B + D ) + {BC}^{2} + {A}^{2} D}{{( A + C )}^{2} + {( B + D )}^{2}}\end{matrix} \qquad ( 5 )$$

The computation of the combined impedance Ztotal is so complex that it is difficult to understand it intuitively. Therefore, the behavior of the input impedance of the common-drain FET 32 provided with a feedback circuit will be explained by using numerical computation and associated characteristic diagrams. The input equivalent circuit is approximated by a series circuit comprising an input resistor Rin and an input capacitor Cin connected in series. The input capacitor Cin and the input resistor Rin are extracted from the total according to the expression (6) below.

$${R}_{i n} = Re ( {Z}_{total} ) , \\ {C}_{i n} = - \frac{1}{ω Im ( {Z}_{total} )} \qquad ( 6 )$$

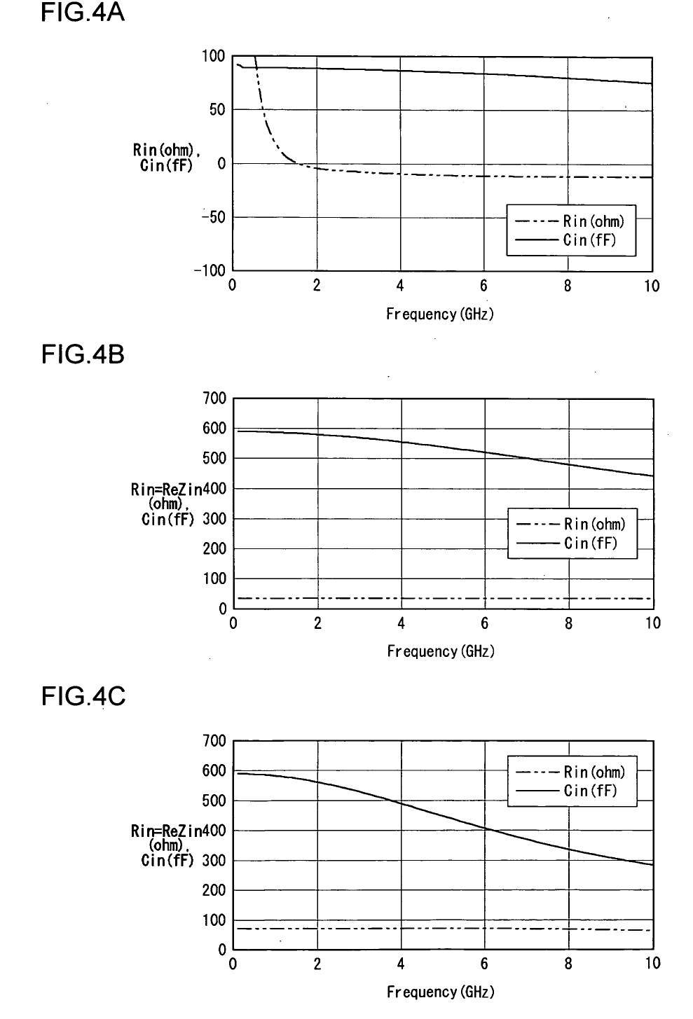

FIGS. 4A-4C are charts showing examples of extracting the input equivalent circuit of the common-drain FET 32 provided with a feedback circuit. FIG. 4A shows a case where the feedback capacitor Cf=0 pF and there is no feedback circuit; FIG. 4B shows a case where the feedback capacitor Cf=0.5 pF and the feedback resistor Rf=50Ω; and FIG. 4C shows a case where the feedback capacitor Cf=0.5 pF and the feedback resistor Rf=100Ω. It will be assumed here that the load resistor RL=50Ω, the gate-source parasitic capacitance Cgs=the drain-source parasitic capacitance Cds=0.2 pF, and the transconductance gm=25 mS.

As shown in FIG. 4A, in the absence of a feedback circuit, the input capacitor Cin has a value as small as about 90 fF and the input resistor Rin even has a negative value. This is mainly due to the values of the load resistor RL and the transconductance gm. FIG. 4B shows that, in the 3-5 GHz band, the input resistor Rin has a value on the order of 10-100Ω and is substantially constant, and the input capacitor Cin has a value on the order of 100-1000 fF and is also substantially constant. FIG. 4C shows that the input resistor Rin has a higher value and is substantially constant in the 3-5 GHz band.

This shows that, by providing a feedback circuit, the input equivalent circuit of the common-drain FET 32 can be represented by a series equivalent circuit comprising an input resistor Rin and an input capacitor Cin connected in series. In practice, the circuit is designed by using an FET high-frequency model that allows for various parasitic components. Therefore, it is more practical to determine the values of the input capacitor Cin and the input resistor Rin by optimization using a high-frequency simulator rather than on the basis of the numerical computation shown herein.

For example, given the condition of FIG. 4C, the input resistor Rin has a substantially constant value of 70Ω in the 3-5 GHz band. However, the input capacitor Cin has a value that varies in the numerical range of 526 fF-447 fF. Accordingly, if the value of the input resistor Rf is high, the frequency dependence of the value of the input capacitor Cin will be more prominent. Accordingly, it is preferable that the value of the input resistor Rf be not so high. When the resistance or capacitance is not substantially constant as in this case, it is practical to represent the value by an average or a median in a desired band. It should be noted that the explanation herein uses a simplified model so that the numerical examples given differ from those produced when the actual high-frequency model is used.

A description will now be given of the output equivalent circuit at the RF signal output terminal of the mixer (III).

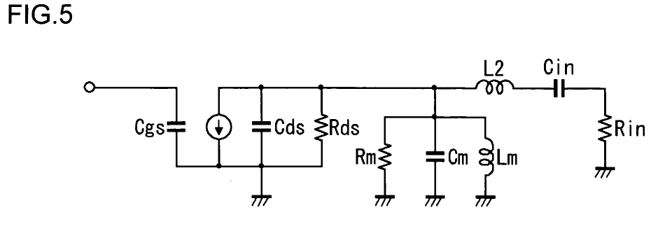

FIG. 5 shows the equivalent circuit as viewed from the mixer output terminal. As shown in FIG. 5, the equivalent circuit of the FET at the RF signal output terminal of the mixer is approximated by a parallel circuit comprising a drain-source parasitic resistor Rds and a drain-source parasitic capacitor Cds. By providing a parallel circuit comprising a mixer load resistor Rm, a miser load capacitor Cm, and a mixer load inductor Lm between the RF signal output terminal and the power supply, the circuit parameters as viewed from the mixer output are given by the expression (7) below. FIG. 5 also shows a gate-source parasitic capacitor Cgs.

$${C}_{out} = {C}_{ds} + {C}_{m} , \\ {R}_{out} = \frac{{R}_{ds} \cdot {R}_{m}}{{R}_{ds} + {R}_{m}} , \\ {L}_{out} = {L}_{m} \qquad ( 7 )$$

The expression (7) above is valid because the terminal supplying a source voltage is ac-grounded so that the internal capacitor and internal resistor of the FET, and the capacitor and resistor of the load circuit can be viewed as being connected in parallel.

It will be learned from (II)-(III) that the input equivalent circuit of the CDF provided with a feedback circuit is represented by a series circuit comprising the input resistor Rin and the input capacitor Cin connected in series. The mixer output terminal can be represented by a parallel circuit comprising the output capacitor Cout, the output resistor Rout, and the output inductor Lout connected in parallel. By inserting a second inductor L2 between the mixer output terminal and the input terminal of the CDF, the same circuit configuration as that of the second-order BPF described in (I) is produced. For example, by configuring the circuit as given by the expression (8) below on the basis of the expression (1) above, the second-order Butterworth BPF is produced. The configuration of the circuit parameters is relatively flexible as will be shown in the exemplary embodiments described below.

Rᵢₙ=Rₒᵤₜ=R_{O}=50Ω,

Cₒᵤₜ=C₁,

Lₒᵤₜ=Lₘ=L₁,

L₂=L₂,

Cᵢₙ=C₂ (8)

A description will now be given of the frequency characteristic of conversion gain (IV).

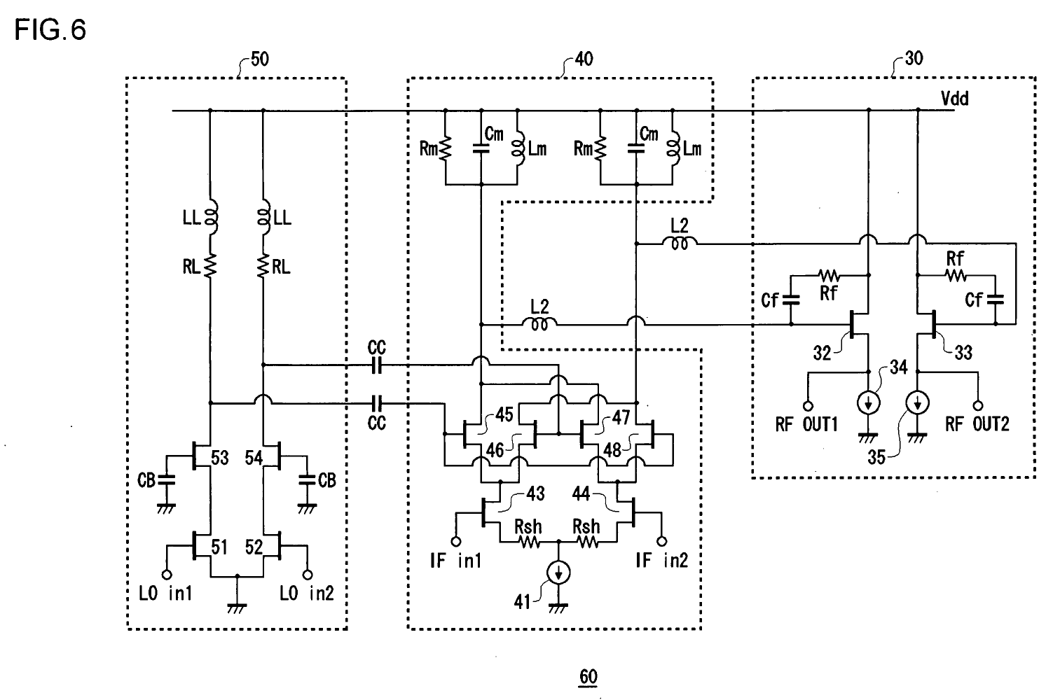

FIG. 6 shows the overall configuration of a transmission mixer circuit 60 according to the embodiment. The transmission mixer circuit 60 is provided with a local buffer amplifier 50, a mixer circuit 40, and an output buffer 30. The local buffer amplifier 50 is provided with FETs in cascode connection forming differential pairs and respectively provided with inductive loads.

The FETs in cascode connection include common-source FETs forming a differential pair and common-gate FETs forming a differential pair. By increasing effective output resistance, the gain is increased. The common-source FETs include a first FET 51 and a second FET 52. The source terminals of the first FET 51 and the second FET 52 are grounded. A first local input signal LOin1 is fed to the gate terminal of the first FET 51, and a second local input signal LOin2 is fed to the gate terminal of the second FET 52.

The common-gate FETs include a third FET 53 and a fourth FET 54 forming a differential pair. The source terminals of the third FET 53 and the fourth FET 54 are connected to the drain terminals of the first FET 51 and the second FET 52, respectively. A predetermined fixed potential is applied to the gate terminals of the third FET 53 and the fourth FET 54. Bypass capacitors CB are connected between the ground and the gate terminals of the third FET 53 and the fourth FET 54. The drain terminals of the third FET 53 and the fourth FET 54 are connected to the inductive loads.

The inductive loads are connected between the power supply Vdd and the drain terminals of the third FET 53 and the fourth FET 54. The inductive load is formed by a series circuit comprising a load resistor RL and a load inductor LL connected in series. The differential output signals of the local buffer amplifier 50 are fed to the mixer circuit 40 via respective coupling capacitors CC.

The mixer circuit 40 is a Gilbert cell mixer. The mixer circuit 40 is provided with common-source FETs forming a differential pair. The common-source FETs include a fifth FET 43 and a sixth FET 44. The source terminals of the fifth FET 43 and the sixth FET 44 are connected via respective source-ground resistors Rsh to a tail constant-current source 41 having one end thereof connected to the ground. A first intermediate signal IFin1 and a second intermediate signal IFin2 are fed to the gate terminals of the fifth FET 43 and the sixth FET 44, respectively.

The mixer circuit 40 is further provided with a seventh FET 45 and an eighth FET 46 forming a differential pair, and a ninth FET 47 and a tenth FET 48 forming a differential pair. The source terminals of the seventh FET 45 and the eighth FET 46 are commonly connected to the drain terminal of the fifth FET 43. Similarly, the source terminals of the ninth FET 47 and the tenth FET 48 are commonly connected to the drain terminal of the sixth FET 44.

One of the differential output signals from the local buffer amplifier 50 is fed to the gate terminals of the seventh FET 45 and the tenth FET 48. The other differential output signal from the local buffer amplifier 50 is fed to the gate terminals of the eighth FET 46 and the ninth FET 47. The drain terminal of the seventh FET 45 is connected to the drain terminal of the ninth FET 47 and the common output terminal is connected to a resonator load. Similarly, the drain terminal of the eighth FET 46 is connected to the drain terminal of the tenth FET 48 and the common output terminal is connected to a resonator load.

Each of the resonator loads is formed by a parallel circuit comprising a mixer load resistor Rm, a mixer load capacitor Cm, and a mixer load inductor Lm connected in parallel and is connected between the output terminal and a power supply Vdd. The differential output signals of the mixer circuit 40 are fed to the output buffer 30 via the respective second inductors L2.

The output buffer 30 is formed by a differential pair of the circuits described with reference to FIGS. 3A and 3B. The output buffer is provided with the first common-drain FET 32 and the second common-drain FET 33 forming a differential pair. The drain terminals of the first common-drain FET 32 and the second common-drain FET 33 are connected to the power supply Vdd.

One of the differential output signals from the mixer circuit 40 is fed to the gate terminal of the first common-drain FET 32. The other differential output signal from the mixer circuit 40 is fed to the gate terminal of the second common-drain FET 33. A feedback circuit comprising a feedback resistor Rf and a feedback capacitor Cf connected in series is coupled between the gate and the drain of each of the first common-drain FET 32 and the second common-drain FET 33. The source terminals of the first common-drain FET 32 and the second common-drain FET 33 are connected to constant-current sources 34 and 35, respectively. One end of each of the constant-current sources 34 and 35 is connected to the ground. A first transmission signal RFout1 and a second transmission signal RFout2, which are output from the output buffer 30, are transmitted via a power amplifier and an antenna.

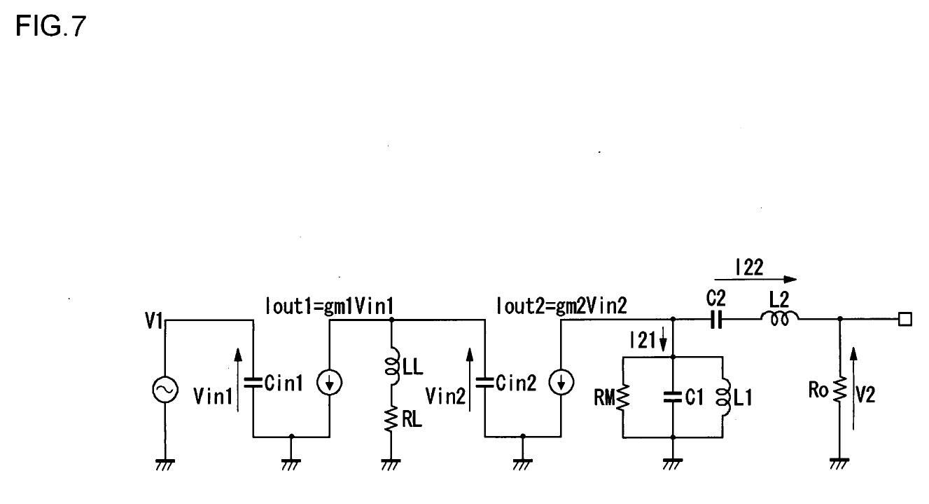

In order to derive a transfer function of the transmission mixer 60, the circuit shown in FIG. 6 is modeled as shown in FIG. 7.

FIG. 7 is a diagram illustrating the principle for explaining the frequency characteristic of conversion gain of the transmission mixer circuit 60 according to the embodiment. It will be assumed that the circuit parameters are configured so that a second-order Butterworth BPF is formed between the mixer circuit 40 and the output buffer 30. The output resistor Ro and the input resistor RM at the respective ends of the BPF are assumed to have different values in consideration of cases where reference impedances differ. The circuit equation of the equivalent circuit shown in FIG. 7 is given by the expression (9) below.

$${V}_{1} = {V}_{IN 1} \\ {I}_{OUT 1} = {g}_{m 1} {V}_{IN 1} \\ {V}_{IN 2} = - {I}_{OUT 1} \frac{{Z}_{L} {Z}_{IN 2}}{{Z}_{L} + {Z}_{IN 2}} \\ {I}_{OUT 2} = {g}_{m 2} {V}_{IN 2} = - ( {I}_{21} + {I}_{22} ) \\ {I}_{22} = ( {I}_{21} + {I}_{22} ) \frac{{Z}_{1}}{{Z}_{1} + {Z}_{2} + {Z}_{3}} \\ {V}_{2} = {Z}_{3} {I}_{22} \\ ∵ {Z}_{IN 2} = \frac{1}{jω {C}_{i n 2}} , \\ {Z}_{L} = {R}_{L} + jω {L}_{L} \\ ∵ {Z}_{1} = \frac{1}{\frac{1}{{R}_{M}} + \frac{1}{jω {L}_{1}} + jω {C}_{1}} , \\ {Z}_{2} = jω {L}_{2} + \frac{1}{jω {C}_{2}} , \\ {Z}_{3} = {R}_{O} \qquad ( 9 )$$

Therefore, the transfer function is given by the expression (10) below.

$$\frac{{V}_{2}}{{V}_{1}} = \frac{{Z}_{1} {Z}_{3}}{{Z}_{1} + {Z}_{2} + {Z}_{3}} \cdot {g}_{m 1} {g}_{m 2} \frac{{Z}_{L} {Z}_{IN 2}}{{Z}_{L} + {Z}_{IN 2}} \qquad ( 10 )$$

Solving the expression (10) and using the relation of (1), the transfer function can be obtained as below.

$$\vert \frac{{V}_{2}}{{V}_{1}} \vert = \frac{\sqrt{\begin{matrix}{{A}^{2} ( {R}_{O} + {R}_{M} )}^{2} + \\ {( {BR}_{M} - {R}_{M} {A}^{2} \frac{1}{B} + {BR}_{O} )}^{2}\end{matrix}}}{\begin{matrix}{{A}^{2} ( {R}_{O} + {R}_{M} )}^{2} + \\ ( {BR}_{M} - {R}_{M} {A}^{2} \frac{1}{B} + {BR}_{O} )\end{matrix}} {BR}_{M} {R}_{O} \times \frac{\sqrt{\begin{matrix}{R}_{L}^{2} {D}^{4} + {{D}^{2} ( {C}^{2} - CD + {R}_{L}^{2} )}^{2} \\ {( {C}^{2} - CD + {R}_{L}^{2} )}^{2}\end{matrix}}}{{R}_{L}^{2} + {( C - D )}^{2}} {g}_{m 1} {g}_{m 2} \\ ∵ A ≡ 1 - {( \frac{ω}{{ω}_{C}} )}^{2} , \\ B ≡ \frac{{ωω}_{BW}}{k {ω}_{C}^{2}} , \\ C ≡ ω {L}_{L} , D ≡ \frac{1}{ω {C}_{IN}} \qquad ( 11 )$$

As indicated by the expression (11) above, the transfer function of the transmission mixer 60 as a whole is complex. The behavior will be explained by using numerical computation and associated characteristic diagrams.

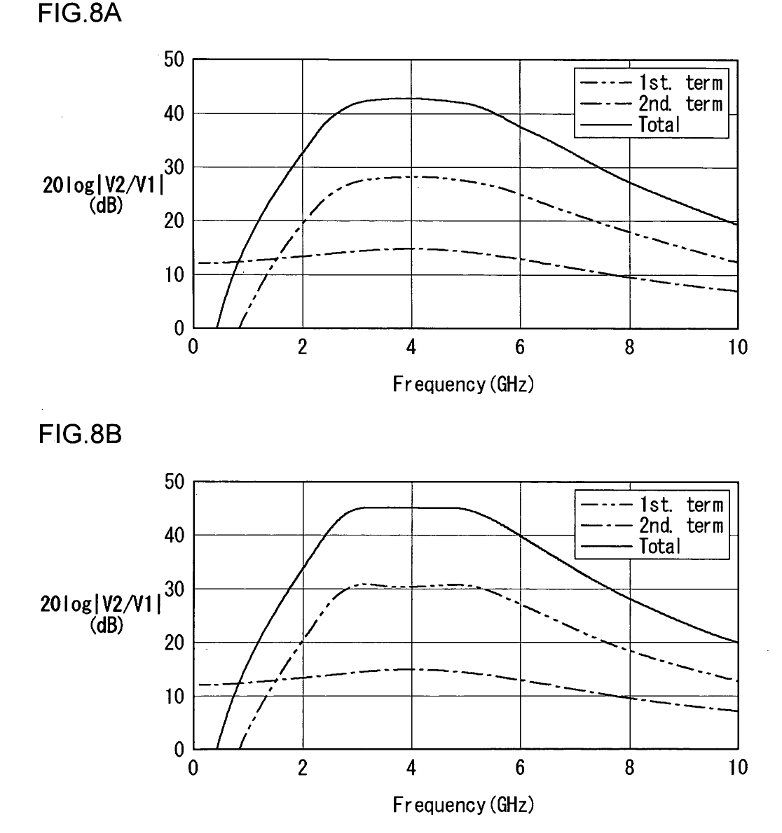

FIGS. 8A and 8B show the frequency characteristic of conversion gain. FIG. 8A shows a case where the input resistor RM=50Ω, and FIG. 8B shows a case where the input resistor RM=200Ω. In both cases, the transconductance gm1 of the FET included in the local buffer amplifier 50 is such that gm1=25.93 mS, the transconductance gm2 of the FET included in the mixer circuit 40 is such that gm2=2.083 mS, the input capacitance Cin=0.468 pF, the load resistance RL=70Ω, the output resistance Ro=50Ω, the bandwidth fbw=3.5 GHz, and the central frequency fc=3.873 GHz. Referring to the figure, the curve in the middle represents the first term of the transfer function, the bottom line the second term, and the top line the overall characteristic.

As shown in FIG. 8A, when the output resistance Ro=input resistance RM=50Ω, the first term of the transfer function exhibits a flat characteristic, but the overall characteristic indicates that the gain increases around specific frequencies. As shown in FIG. 8B, by configuring the input resistance such that Rm=100Ω and thus providing a ripple in the first term of the transfer function, a flat overall characteristic results. For adjustment of the input resistance RM, the value of the mixer load resistor Rm may be adjusted. The maximum value of RM results by eliminating the mixer load resistor Rm and is equal to the value of the drain-source resistor Rds, which represents the output resistor of the FET.

As described above, the load circuit of the local buffer amplifier 50 and the BPF formed between the mixer circuit 40 and the output buffer 30 produce a flat gain characteristic in a desired band.

In deriving the input impedance of the mixer output buffer, it is assumed that one end of the series circuit comprising the feedback resistor Rf and the feedback capacitor Cf connected in series is connected to the gate terminal of the common-drain FET and the other end is connected to the ground potential (see FIGS. 3A and 3B). Regardless of whether the other end of the series circuit is connected to the ground terminal or the power supply terminal, which is ac-grounded, the effect of adjusting the input impedance of the mixer output buffer remains unchanged. Accordingly, the series circuit may be inserted between the gate terminal of the common-drain FET and the ground terminal or between the gate terminal of the common-drain FET and the power supply terminal.

A description will now be given of an exemplary embodiment using the principle explained in the embodiment.

First, the first exemplary embodiment will be described.

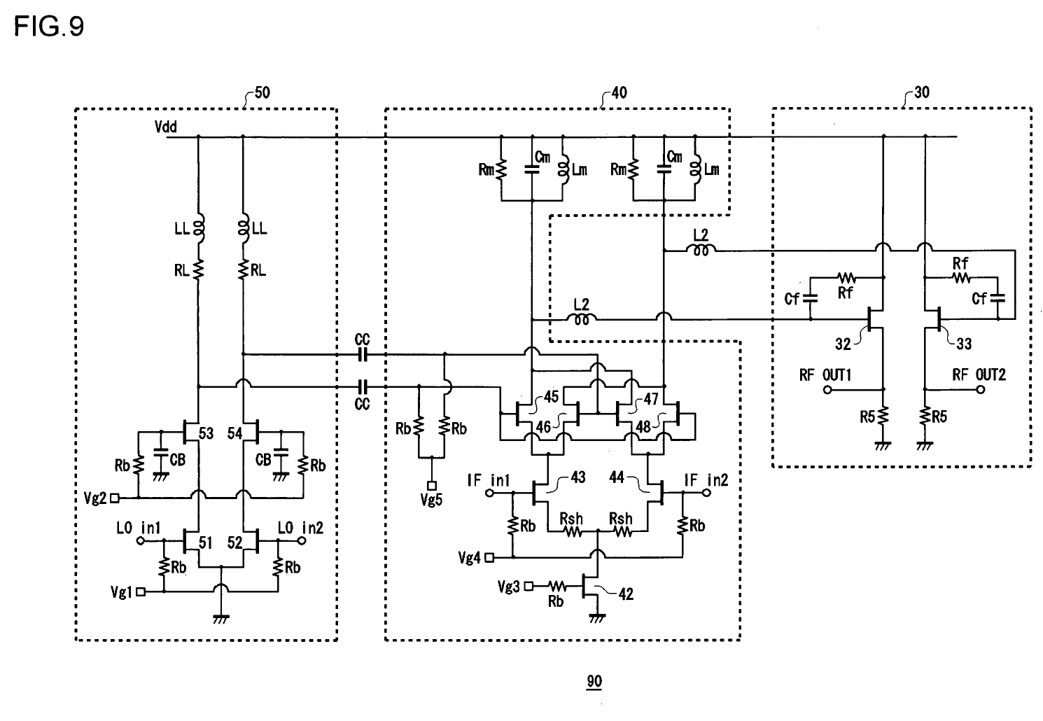

FIG. 9 shows the overall configuration of a transmission mixer 90 according to the first exemplary embodiment. The transmission mixer circuit 90 shown in FIG. 9 is a specific implementation of the transmission mixer circuit 60 shown in FIG. 6. Specific aspects of the implementation will be described below. In the following description, it is assumed that the desired band is set to 3-5 GHz.

A first fixed voltage Vg1 is applied as a bias voltage to the gate terminals of the first FET 51 and the second FET 52 of the local buffer amplifier 50 via respective bias resistors Rb. A second fixed voltage Vg2 is applied as a bias voltage to the gate terminals of the third FET 53 and the fourth FET 54 via respective bias resistors Rb.

The first FET 51, the second FET 52, the third FET 53, and the fourth FET 54 are configured such that the gate length is 0.18 μm and the gate width is 100 μm. The power supply voltage Vdd is set at 1.8 V, the gate voltage of the first FET 51 and the second FET 52 is set at 0.62 V, the gate voltage of the third FET 53 and the fourth FET 54 is set at 1.5 V, and the overall operating current is set at 6.1 mA.

The tail current source 41 of the mixer circuit 40 is formed by a tail FET 42 in which a third fixed voltage Vg3 is applied as a bias voltage to the gate terminal via a bias resistor Rb. A fourth fixed voltage Vg4 is applied as a bias voltage to the gate terminals of the fifth FET 43 and the sixth FET 44 via respective bias resistors Rb. A fifth fixed voltage Vg5 is applied as a bias voltage to the gate terminals of the seventh FET 45, the eighth FET 46, the ninth FET 47, and the tenth FET 48 via respective bias resistors Rb.

The tail FET 42, the fifth FET 43, the sixth FET 44, the seventh FET 45, the eighth FET 46, the ninth FET 47, and the tenth FET 48 are configured such that the gate length is 0.18 μm. The gate width of the tail FET 42 is set at 300 μm, the gate width of the fifth FET 43 and the sixth FET 44 is set at 300 μm, and the gate width of the seventh FET 45, the eighth FET 46, the ninth FET 47, and the tenth FET 48 is set at 200 μm. The power supply voltage is set at 1.8 V, the gate voltage of the tail FET 42 is set at 0.62 V, the gate voltage of the fifth FET 43 and the sixth FET 44 is set at 1.12 V, the gate voltage of the seventh FET 45, the eighth FET 46, the ninth FET 47, and the tenth FET 48 is set at 1.55 V, and the overall operating current is set at 7.21 mA.

The constant-current sources 34 and 35 of the output buffer 30 are formed by respective source resistors Rs. The first common-drain FET 32 and the second common-drain FET 33 are configured such that the gate length is 0.18 μm and the gate width is 200 μm. The power supply voltage is set at 1.8 V, the gate voltage is set at 1.8 V, and the overall operating current is set at 3.34 mA. The value of the source resistor Rs is set at 700Ω.

As mentioned before, a model allowing for various parasitic components is actually used in order to precisely represent the operation of the high-frequency MOSFET. Therefore, it would be practical to employ a method of determining parameters by optimization based upon a high-frequency simulator in order to derive an input equivalent circuit of the CDF provided with a feedback circuit.

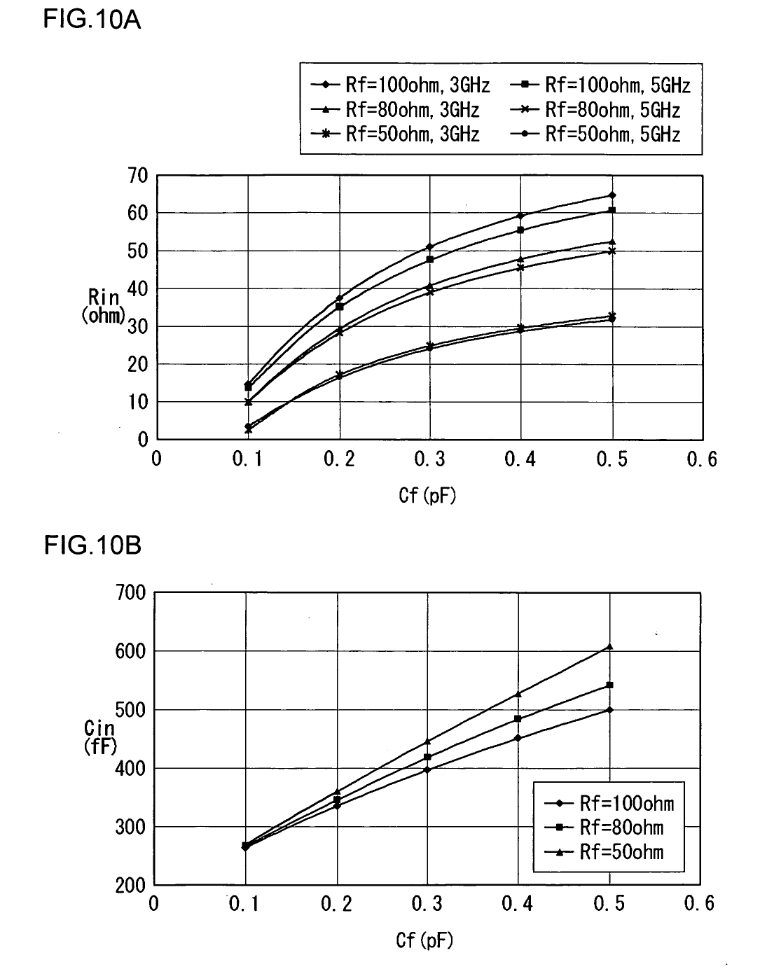

FIGS. 10A and 10B are graphs plotting circuit parameters of an input equivalent circuit of the common-drain FET provided with a feedback circuit. FIG. 10A shows the dependence of the input resistance Rin on the feedback capacitance Cf and the feedback resistance Rf, and FIG. 10B shows the dependence of the input capacitance Cin on the feedback capacitance Cf and the feedback resistance Rf. The frequency dependence of the input resistance Rin is not negligible with an increase in the feedback resistance Rf. Therefore, a simple series circuit comprising the input resistor Rin and the input capacitor Cin connected in series can no longer be used for proper approximation. For example, the feedback resistance Rf of 100Ω or greater would not be practical.

The circuit parameters of the BPF will be determined. Since the desired operating band is 3-5 GHz, the band 2.5-6 GHz will be set as the BPF band. In this case, the central frequency is 3.873 GHz and remains unchanged. The bandwidth is 3.5 GHz. The circuit parameters of the second-order Butterworth BPF will be as listed in table 1.

In order to produce the first inductance L1, the first capacitance C1, and the second inductance L2, and the second capacitance C2 listed in the table 1, the feedback resistance Rf and the feedback capacitance Cf of the output buffer 30 are set at 80Ω and 0.5 pF, respectively. The input resistance Rin and the input capacitance Cin of the input equivalent circuit of the output buffer 30 are thus set at about 50Ω and 0.52 pF, respectively.

The output equivalent circuit as viewed from the RF signal output terminal of the mixer circuit 40, i.e., as viewed from the drain terminals of the seventh FET 45, the eighth FET 46, the ninth FET 47, and the tenth FET 48 can be approximated by a parallel circuit comprising the drain-source capacitor Cds=0.3155 pF and the drain-source resistor Rds=340.1Ω in the exemplary embodiment. Therefore, the mixer load resistor Rm and the mixer load capacitor Cm forming the load circuit are set at 58.6Ω and 0.971 pF, respectively so that the combined values given by the expression (7) substantially match the values of the first capacitor C1 and the output resistor Ro. The mixer load inductor Lm is set such that Lm=L1=3.215 nH, and the second inductor L2 between the output terminal of the mixer circuit 40 and the input terminal of the output buffer 30 is set such that L2=1.313 nH.

TABLE 1

| | | REFLECTION LOSS |
|---|---|---|
| BAND | L1, C1, L2, C2 | (3~5 GHz) |
| 3.5 GHz | L1 = 1.313nH, C1 = 1.286 pF | −10.6 dB OR LOWER |
| | L2 = 3.215nH, C2 = 0.525 pF | |

Finally, the load resistor RL and the load inductor LL forming the load circuit of the local buffer amplifier 50 are set at 30Ω and 2.5 nH, respectively, in consideration of the frequency dependence of conversion gain.

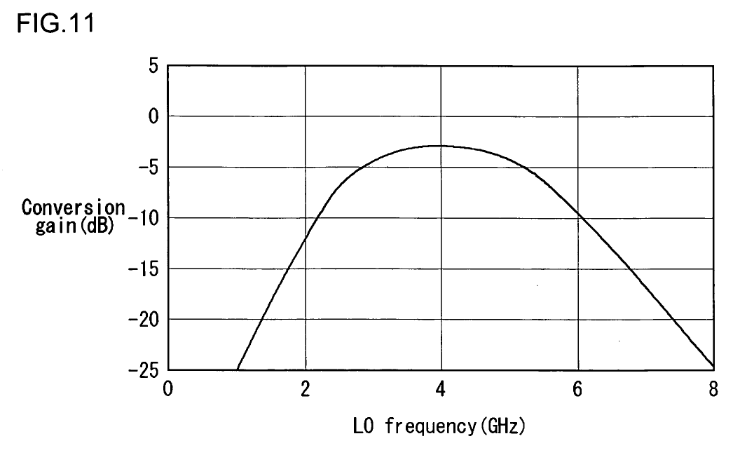

FIG. 11 shows the frequency characteristic of the transmission mixer circuit 90 according to the first exemplary embodiment. FIG. 11 shows that the conversion gain of −4 dB or greater is available at 3-5 GHz, and the 3 dB bandwidth is 2.7 GHz. At around 4 GHz, the conversion gain reaches a maximum value of −2.9 dB. The conversion gain is not set so high because linearity is more of a concern than gain. Also considered is the fact that the source-ground resistor Rsh (in FIG. 9, 30Ω) is coupled between the ground and the source terminals of the fifth FET 43 and the sixth FET 44 of the mixer circuit 40.

As described above, a flat gain characteristic in a desired band is produced according to the exemplary embodiment by providing the BPF characteristic between the mixer circuit 40 and the output buffer 30. Since there is no need to provide a filter element additionally, the flat characteristic can be achieved without increasing the circuit scale.

A description will now be given of the second exemplary embodiment.

In the second exemplary embodiment, the reference impedance at one end of the BPF is varied. A difference from the first exemplary embodiment is that the mixer load resistor Rm is removed from the load circuit of the mixer circuit 40. As a result, the value of the reference impedance at one end of the BPF is equal to the value of the drain-source resistor Rds of the FET so that a flat gain as discussed above is available. The load resistors RL of the load circuit of the local buffer amplifier 50 are changed in value to 40Ω. The load inductor LL is allowed to remain unchanged at 2.5 nH.

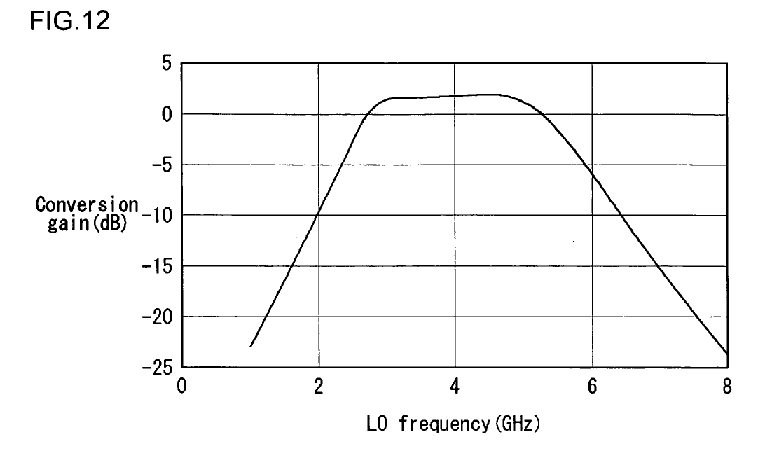

FIG. 12 shows the frequency characteristic of the transmission mixer circuit according to the second exemplary embodiment. In the 3-5 GHz band, the conversion gain is 1.2-1.7 dB, meaning a gain variation of about 0.5 dB. In this exemplary embodiment, the mixer load resistor Rm is removed. Alternatively, the mixer load resistor Rm may not be removed and adjusted to a proper value to ensure the flatness of the gain. A relatively high value (e.g., 50Ω or higher) is desirable. According to the second exemplary embodiment, the gain variation in the desired band can be adjusted by adjusting the mixer load resistor Rm.

A description will now be given of the third exemplary embodiment.

In the third exemplary embodiment, an output buffer formed by FETs in cascode connection is used in place of the output buffer 30 formed by common-drain FETs provided with a feedback circuit as described above.

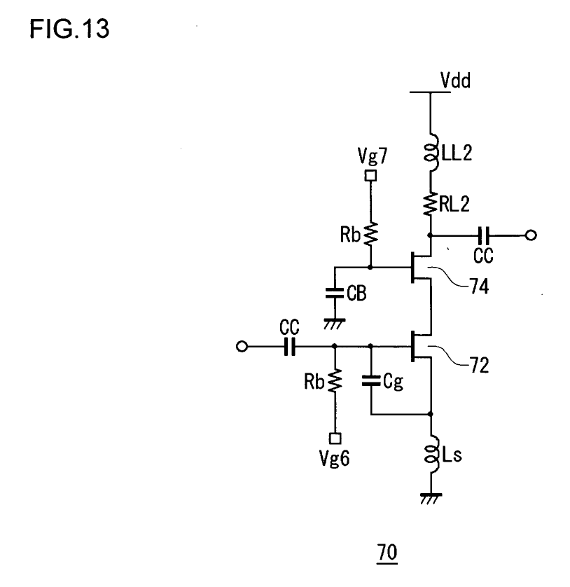

FIG. 13 shows the circuit configuration of an output buffer 70 according to the third exemplary embodiment. The output buffer 70 according to the third exemplary embodiment is provided with FETs in cascode connection and an inductive load. The FETs in cascode connection include a common-source FET 72 and a common-gate FET 74.

The source terminal of the common-source FET 72 is connected to a source inductor Ls having one end thereof connected to the ground. The output signal from the mixer circuit is fed to the gate terminal of the common-source FET 72 via a coupling capacitor CC. A sixth fixed voltage Vg6 is applied as a bias voltage to the gate terminal of the common-source FET 72 via a bias resistor Rb. A gate-source capacitor Cg is coupled between the gate and the source of the common-source FET 72.

The source terminal of the common-gate FET 74 is connected to the drain terminal of the common-source FET 72. A seventh fixed voltage Vg7 is applied as a bias voltage to the gate terminal of the common-gate FET 74 via a bias resistor Rb. A bypass capacitor CB is coupled between the gate terminal of the common-gate FET 74 and the ground. The drain terminal of the common-gate FET 74 is connected to the inductive load.

The inductive load is formed by a series circuit comprising a second load resistor RL2 and a second load inductor LL2 connected in series and is coupled between the drain terminal of the common-gate FET 74 and the power supply Vdd. The output signal of the output buffer 70 is output to, for example, a power amplifier (not shown) via the coupling capacitor CC.

In the output buffer 70 according to this exemplary embodiment, the gate-source capacitor Cg is coupled between the gate and the source of the common-source FET 72 and the source inductor Ls is coupled between the source terminal of the common-source FET 72 and the ground so that the input resistor Rin and the input capacitor Cin, connected in series to form the input equivalent circuit of the output buffer 70, are configured at desired values.

The common-source FET 72 and the common-gate FET 74 are configured such that the gate length is 0.18 μm and the gate width is 100 μm. The power supply voltage is set at 1.8 V, the gate voltage of the common-source FET 72 is set at 0.7 V, the gate voltage of the common-gate FET 74 is set at 1.5 V, and the overall operating current is set at 10.72 mA.

By configuring the gate-source capacitor Cg and the source inductor Ls such that Cg=0.34 pF and Ls=0.7 nH in the output buffer 70 of this exemplary embodiment, the input impedance of the common-source FET 72 is approximated by an input equivalent circuit where the input capacitor Cin=0.524 pF and the input resistor Rin=49.3Ω. These values are close to the values of the second capacitor C2 and the output resistor Ro of the BPF discussed in the first exemplary embodiment. A series circuit comprising the second load resistor RL2 and the second load capacitor LL2 connected in series is used as a load circuit of the FETs in cascode connection, RL2 and LL2 being inductive loads. The second load resistor RL2 and the second load inductor LL2 are set such that RL2=80Ω and LL2=2.0 nH in consideration of the frequency dependence of conversion gain.

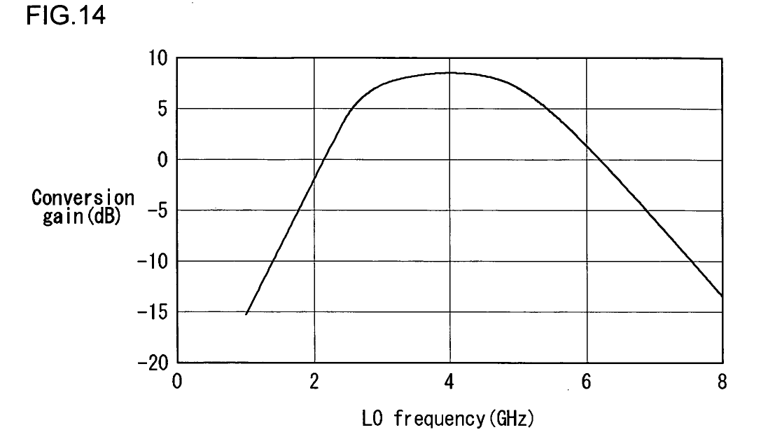

FIG. 14 shows the frequency characteristic of the transmission mixer circuit 90 according to the third exemplary embodiment. The conversion gain is 7.0 dB or higher in the 3-5 GHz band. As described above, the output buffer 70 of this exemplary embodiment operates as an amplifier circuit so that the conversion gain higher than that of the first exemplary embodiment by 10 dB or more is obtained. Accordingly, the output buffer 70 can also be used as a front amplifier for a power amplifier connected to follow the transmission mixer circuit 90, with the result that the configuration of the transmission circuit as a whole is simplified.

Finally, a description will now be given of the fourth exemplary embodiment.

The fourth exemplary embodiment is designed to ensure a high conversion gain and a flat frequency characteristic in the target band by using the output buffer 70 of the third exemplary embodiment and adjusting the value of the input resistor RM of the BPF. The second load resistor RL2 and the second load inductor LL2 forming the load circuit in the amplifier stage of the output buffer 70 with cascode-connected FETs are set such that RL2=70Ω and LL2=2.0 nH, respectively.

The output equivalent circuit as viewed from the RF signal output terminal of the mixer circuit 40, i.e., as viewed from the drain terminals of the seventh FET 45, the eighth FET 46, the ninth FET 47, and the tenth FET 48 can be approximated by a parallel circuit comprising the drain-source capacitor Cds=0.3155 pF and the drain-source resistor Rds=340.1Ω as in the first exemplary embodiment. The mixer load resistance Rm and the mixer load capacitance Cm forming the load circuit are set at 200Ω and 0.971 pF, respectively. The output resistance Ro, the combined value given by the expression (7), need not be set at 50Ω.

As in the first exemplary embodiment, the other circuit parameters are set such that the load inductor Lm=the first inductor L1=3.215 nH. The second inductor L2 between the output terminal of the mixer circuit 40 and the output buffer 70 is set such that L2=1.313 nH.

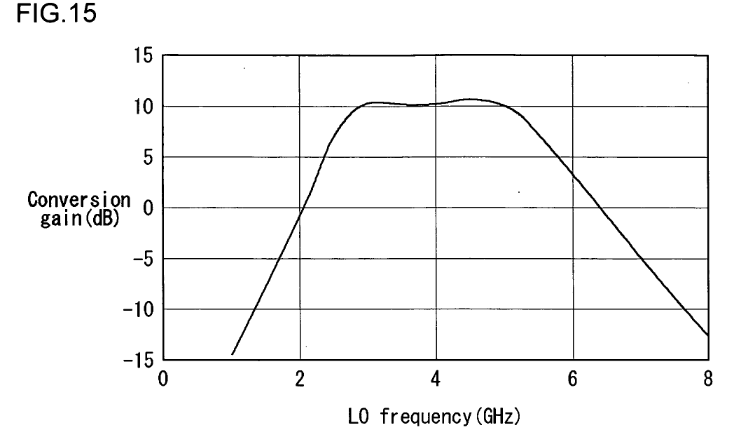

FIG. 15 shows the frequency characteristic of the transmission mixer circuit 90 according to the fourth exemplary embodiment. The conversion gain is about 10 dB in the 3-5 GHz band. As described, a high conversion gain and a flat frequency characteristic in the target band are achieved according to this exemplary embodiment.

In the first through fourth exemplary embodiments, the bypass capacitor CB and the coupling capacitor CC may be designed to have large capacitance (e.g., 10 pF in the GHz band). A high resistance of, for example, 2 KΩ may be used for the bypass resistor Rb.

In the exemplary embodiments, the circuits are described as being formed by ideal inductors L and capacitors C. In practice, however, the design is affected by the constraints from device fabrication processes and parasitic components. However, these are matters of design and the applicability of the inventive principle is not affected.

Described above is the embodiment embodying the present invention. The embodiment is intended to be illustrative only and it will be obvious to those skilled in the art that various modifications to constituting elements and processes could be developed and that such modifications are also within the scope of the present invention.

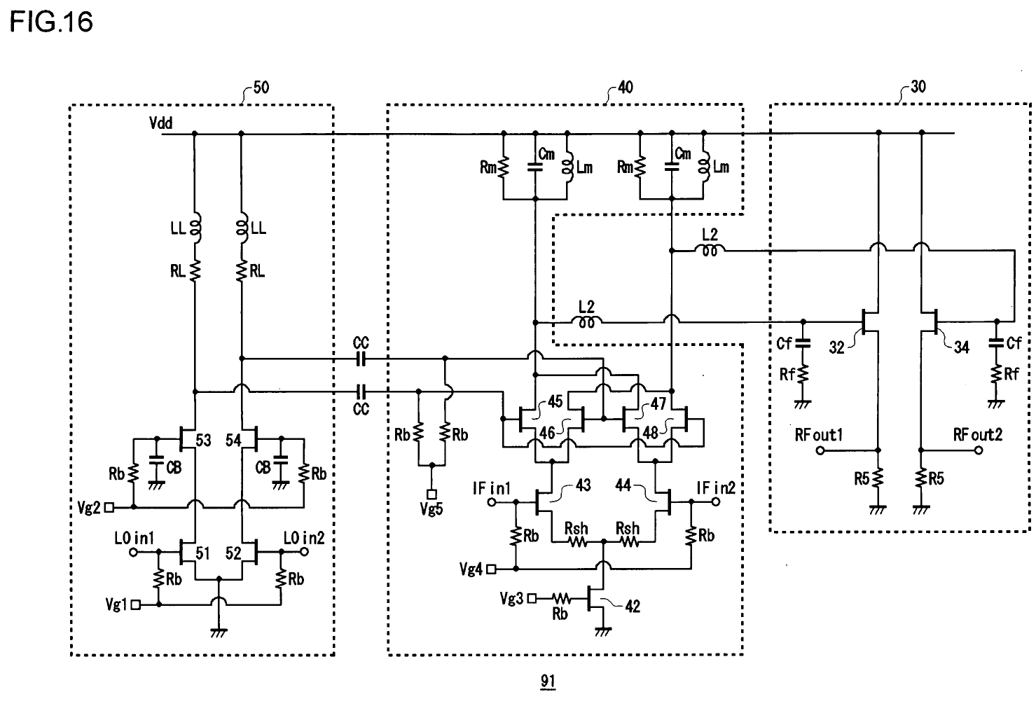

FIG. 16 shows the overall configuration of a transmission mixer circuit 91 according to a variation of the first exemplary embodiment. In the transmission mixer circuit 91, the series circuit comprising the feedback resistor Rf and the feedback capacitor Cf connected in series is not inserted between the gate terminal and the drain terminal of each of the first common-drain FET 32 and the second common-drain FET 33 but between the gate terminal and the ground terminal. The other aspects of the configuration are the same as the corresponding aspects of the transmission mixer circuit 90 shown in FIG. 9 so that the description thereof is omitted. The circuit 91 according to this variation provides the same advantage as the transmission mixer circuit 90 shown in FIG. 9.

In the exemplary embodiments, cases are described in which the second-order Butterworth BPF represents an interstage matching circuit between the mixer circuit and the output buffer. The BPF may be any n-th order BPF, where n is an arbitrary number, or may have alternative pass characteristics. The mixer circuit is described as being a Gilbert mixer, which is a double-balance mixer. Alternatively, an FET mixer such as a single-balance mixer may be used. The transmission circuit is described as being of a differential type. However, a single-end type also serves the purpose. While MOSFETs are used as active devices, bipolar transistors or FETs/transistors using compound semiconductors may also be used. All of the variations discussed above produce the same advantage as the exemplary embodiments described above.

Finally, a supplementary description will be given of the circuit equation for deriving an input equivalent circuit of the common-drain FET provided with a feedback circuit. The expression (12) below more specifically defines the input impedance Zin, given by the expression (3), of the common-drain FET 32 taken alone.

$${V}_{1} = {I}_{1} {Z}_{1} + ( {I}_{1} + {g}_{m} {Z}_{1} {I}_{1} ) {Z}_{2} = ( {Z}_{1} + {Z}_{2} + {g}_{m} {Z}_{1} {Z}_{2} ) {I}_{1} \\ \begin{matrix}{Z}_{IN} = \frac{{V}_{1}}{{I}_{1}} \\ = {Z}_{2} ( {I}_{1} + {g}_{m} {Z}_{1} ) + {Z}_{1} \\ = \frac{{R}_{L}}{1 + jω {C}_{ds} {R}_{L}} ( 1 + \frac{{g}_{m}}{jω {C}_{gs}} ) + \frac{1}{jω {C}_{gs}}\end{matrix} \\ \begin{matrix}{Z}_{IN} = \frac{1}{jω {C}_{gs}} ( 1 + \frac{{g}_{m} {R}_{L}}{1 + jω {C}_{ds} {R}_{L}} ) + \frac{{R}_{L}}{1 + jω {C}_{ds} {R}_{L}} \\ = \frac{1}{jω {C}_{gs}} + \frac{{g}_{m} {R}_{L}}{- {ω}^{2} {C}_{ds} {C}_{gs} {R}_{L} + jω {C}_{gs}} + \frac{{R}_{L} ( 1 - jω {C}_{ds} {R}_{L} )}{1 + {( ω {C}_{ds} {R}_{L} )}^{2}} \\ = \frac{1}{jω {C}_{gs}} + \frac{{g}_{m} {R}_{L} ( - {ω}^{2} {C}_{ds} {C}_{gs} {R}_{L} - jω {C}_{gs} )}{{( {ω}^{2} {C}_{ds} {C}_{gs} {R}_{L} )}^{2} + {( ω {C}_{gs} )}^{2}} + \\ \frac{{R}_{L} ( 1 - jω {C}_{ds} {R}_{L} )}{1 + {( ω {C}_{ds} {R}_{L} )}^{2}}\end{matrix} \\ \begin{matrix}Re ( {Z}_{IN} ) = \frac{{R}_{L}}{1 + {( ω {C}_{ds} {R}_{L} )}^{2}} - \frac{{ω}^{2} {C}_{ds} {C}_{gs} {R}_{L}^{2} {g}_{m}}{{( {ω}^{2} {C}_{ds} {C}_{gs} {R}_{L} )}^{2} + {( ω {C}_{gs} )}^{2}} \\ \approx {R}_{L} ( 1 - \frac{{C}_{ds} {R}_{L} {g}_{m}}{{C}_{gs}} )\end{matrix} \\ \begin{matrix}Im ( {Z}_{IN} ) = - j ( \frac{1}{ω {C}_{gs}} + \frac{ω {C}_{gs} {g}_{m} {R}_{L}}{\begin{matrix}{( {ω}^{2} {C}_{ds} {C}_{gs} {R}_{L} )}^{2} + \\ {( ω {C}_{gs} )}^{2}\end{matrix}} + \frac{ω {C}_{ds} {R}_{L}^{2}}{1 + {( ω {C}_{ds} {R}_{L} )}^{2}} ) \\ \approx - j ( \frac{1 + {g}_{m} {R}_{L}}{ω {C}_{gs}} + ω {C}_{ds} {R}_{L}^{2} )\end{matrix} \\ ∵ {( ω {C}_{ds} {R}_{L} )}^{2} ≪ 1 , \\ {( {ω}^{2} {C}_{ds} {C}_{gs} {R}_{L} )}^{2} ≪ {( ω {C}_{gs} )}^{2} , \\ \frac{{( {ω}^{2} {C}_{ds} {C}_{gs} {R}_{L} )}^{2}}{{( ω {C}_{gs} )}^{2}} ≪ \frac{{( ω {C}_{gs} )}^{2}}{{( ω {C}_{g \dot{s}} )}^{2}} \to {( ω {C}_{ds} {R}_{L} )}^{2} ≪ 1 \qquad ( 12 )$$

The expression (13) below more specifically defines the step of computing the combined impedance Ztotal, given by the expression (5) above, comprising the input impedance Zin of the common-drain FET 32 taken alone and the impedance Zf of the feedback circuit.

$${Z}_{f} = {R}_{f} - j \frac{1}{ω {C}_{f}} ≡ A - j B \\ {Z}_{IN} \approx {R}_{L} ( 1 - \frac{{C}_{ds} {R}_{L} {g}_{m}}{{C}_{gs}} ) - j ( \begin{matrix}\frac{1 + {g}_{m} {R}_{L}}{ω {C}_{gs}} + \\ ω {C}_{ds} {R}_{L}^{2}\end{matrix} ) ≡ C - j D \\ \begin{matrix}{Z}_{total} = \frac{{Z}_{f} {Z}_{IN}}{{Z}_{f} + {Z}_{IN}} \\ = \frac{( A - j B ) ( C - j D )}{A + C - j ( B + D )} \\ = \frac{[ ( A C - BD ) - j ( BC + AD ) ( A + C ) + ( BC + AD ) ( B + D ) ]}{{( A + C )}^{2} + {( B + D )}^{2}} \\ = \frac{\begin{matrix}( A C - BD ) ( A + C ) + j ( A C - BD ) ( B + D ) - \\ j ( BC + AD ) ( A + C ) + ( BC + AD ) ( B + D )\end{matrix}}{{( A + C )}^{2} + {( B + D )}^{2}} \\ = \frac{{A}^{2} C + A {C}^{2} - BDA - BDC + {B}^{2} C + BCD + ADB + {AD}^{2}}{{( A + C )}^{2} + {( B + D )}^{2}} + \\ j \frac{ACB + ACD - {B}^{2} D - {BD}^{2} - BCA - {BC}^{2} - {A}^{2} D - ADC}{{( A + C )}^{2} + {( B + D )}^{2}} \\ = \frac{A C ( A + C ) + {B}^{2} C + {AD}^{2}}{{( A + C )}^{2} + {( B + D )}^{2}} - j \frac{BD ( B + D ) + {BC}^{2} + {A}^{2} D}{{( A + C )}^{2} + {( B + D )}^{2}}\end{matrix} \qquad ( 13 )$$

What is claimed is:

1. A high-frequency circuit comprising:
a mixer circuit which receives a local signal and an input signal so as to output a high-frequency signal generated based on those signals; and
an output buffer circuit which receives the high-frequency signal, wherein
a band-pass filter having predetermined characteristics is formed by using the parameters of passive elements included in an output equivalent circuit as viewed from an output terminal of the mixer circuit and the parameters of passive elements included in an input equivalent circuit as viewed from an input terminal of the output buffer circuit.

2. The high-frequency circuit according to claim 1, further comprising:
an interstage inductor coupled between the output terminal and the input terminal, wherein
the mixer circuit comprises a first common-source transistor receiving the input signal at its gate terminal, a second common-source transistor connected to the drain terminal of the first common-source transistor and receiving the local signal at its gate terminal, and a resonator load connected to the drain terminal of the second common-source transistor and including a parallel circuit in which a mixer load inductor and a mixer load capacitor are connected in parallel,
the mixer circuit outputs the high-frequency signal from the drain terminal of the second common-source transistor, the drain terminal of the second common-source transistor representing the output terminal of the mixer circuit, and
the output buffer circuit comprises a common-drain transistor receiving the high-frequency signal at its gate terminal and outputting a signal corresponding to the high-frequency signal from its source terminal, and an adjustment circuit inserted between the gate terminal and the drain terminal of the common-drain transistor and including a series circuit in which an adjustment resistor and an adjustment capacitor are connected in series, the gate terminal of the common-drain transistor representing the input terminal of the output buffer circuit.

3. The high-frequency circuit according to claim 1, further comprising:
an interstage inductor coupled between the output terminal and the input terminal, wherein
the mixer circuit comprises a first common-source transistor receiving the input signal at its gate terminal, a second common-source transistor connected to the drain terminal of the first common-source transistor and receiving the local signal at its gate terminal, and a resonator load connected to the drain terminal of the second common-source transistor and including a parallel circuit in which a mixer load inductor and a mixer load capacitor are connected in parallel,
the mixer circuit outputs the high-frequency signal from the drain terminal of the second common-source transistor, the drain terminal of the second common-source transistor representing the output terminal of the mixer circuit, and
the output buffer circuit comprises a common-drain transistor receiving the high-frequency signal at its gate terminal and outputting a signal corresponding to the high-frequency signal from its source terminal, and an adjustment circuit inserted between the gate terminal of the common-drain transistor and an ac-grounded terminal and including a series circuit in which an adjustment resistor and an adjustment capacitor are connected in series, the gate terminal of the common-drain transistor representing the input terminal of the output buffer circuit.

4. The high-frequency circuit according to claim 2, wherein
the input equivalent circuit representing the input impedance of the common-drain transistor is approximated by a series circuit in which an input resistor and an input capacitor are connected in series,
a first internal equivalent resistor of the common-drain transistor and a second internal equivalent resistor as viewed from the drain terminal of the second common-source transistor represent reference resistors at the respective ends of the band-pass filter,
the band-pass filter may be formed by using a first internal equivalent capacitor of the second common-source transistor, a second internal equivalent capacitor of the common-drain transistor, the mixer load inductor, the interstage inductor, and the mixer load capacitor.

5. The high-frequency circuit according to claim 3, wherein
the input equivalent circuit representing the input impedance of the common-drain transistor is approximated by a series circuit in which an input resistor and an input capacitor are connected in series,
a first internal equivalent resistor of the common-drain transistor and a second internal equivalent resistor as viewed from the drain terminal of the second common-source transistor represent reference resistors at the respective ends of the band-pass filter,
the band-pass filter may be formed by using a first internal equivalent capacitor of the second common-source transistor, a second internal equivalent capacitor of the common-drain transistor, the mixer load inductor, the interstage inductor, and the mixer load capacitor.

6. The high-frequency circuit according to claim 1, further comprising:
an interstage inductor coupled between the output terminal and the input terminal, wherein
the mixer circuit comprises a first common-source transistor receiving the input signal at its gate terminal, a second common-source transistor connected to the drain terminal of the first common-source transistor and receiving the local signal at its gate terminal, and a resonator load connected to the drain terminal of the second common-source transistor and including a parallel circuit in which a mixer load inductor and a mixer load capacitor are connected in parallel,
the mixer circuit outputs the high-frequency signal from the drain terminal of the second common-source transistor, the drain terminal of the second common-source transistor representing the output terminal of the mixer circuit,
the output buffer circuit comprises a third common-source transistor receiving the high-frequency signal at its gate terminal representing the input terminal of the output buffer circuit, a common-gate transistor connected to the drain terminal of the third common-source transistor, an inductive load connected to the drain terminal of the common-gate transistor and including a series circuit in which an output stage load inductor and an output stage load resistor are connected in series, a source inductor inserted between the source terminal of the third common-source transistor and a given fixed potential, and a gate-source capacitor inserted between the gate terminal and the source terminal of the third common-source transistor.

7. The high-frequency circuit according to claim 1, further comprising:
an interstage inductor coupled between the output terminal and the input terminal, wherein
the mixer circuit comprises a first common-emitter transistor receiving the input signal at its base terminal, a second common-emitter transistor connected to the collector terminal of the first common-emitter transistor and receiving the local signal at its base terminal, and a resonator load connected to the collector terminal of the second common-emitter transistor and including a parallel circuit in which a mixer load inductor and a mixer load capacitor are connected in parallel,
the mixer circuit outputs the high-frequency signal from the collector terminal of the second common-emitter transistor, the collector terminal of the second common-emitter transistor representing the output terminal of the mixer circuit, and
the output buffer circuit comprises a common-collector transistor receiving the high-frequency signal at its base terminal and outputting a signal corresponding to the high-frequency signal from its emitter terminal, and an adjustment circuit inserted between the base terminal and the collector terminal of the common-collector transistor and including a series circuit in which an adjustment resistor and an adjustment capacitor are connected in series, the base terminal of the common-collector transistor representing the input terminal of the output buffer circuit.

8. The high-frequency circuit according to claim 1, further comprising:
an interstage inductor coupled between the output terminal and the input terminal, wherein
the mixer circuit comprises a first common-emitter transistor receiving the input signal at its base terminal, a second common-emitter transistor connected to the collector terminal of the first common-emitter transistor and receiving the local signal at its base terminal, and a resonator load connected to the collector terminal of the second common-emitter transistor and including a parallel circuit in which a mixer load inductor and a mixer load capacitor are connected in parallel,
the mixer circuit outputs a high-frequency signal from the collector terminal of the second common-emitter transistor, the collector terminal of the second common-emitter transistor representing the output terminal of the mixer circuit, and
the output buffer circuit comprises the common-collector transistor receiving a high-frequency signal at its base terminal and outputting a signal corresponding to the high-frequency signal from its emitter terminal, and an adjustment circuit inserted between the base terminal of the common-collector transistor and an ac-grounded terminal, and including a series circuit in which an adjustment resistor and an adjustment capacitor are connected in series, the base terminal of the common-collector transistor representing the input terminal of the output buffer circuit.

9. The high-frequency circuit according to claim 2, wherein
the resonator load includes a parallel circuit in which a mixer load inductor, a mixer load resistor, and a mixer load capacitor are connected in parallel.

10. The high-frequency circuit according to claim 3, wherein
the resonator load includes a parallel circuit in which a mixer load inductor, a mixer load resistor, and a mixer load capacitor are connected in parallel.

11. The high-frequency circuit according to claim 1, further comprising:
a local amplifier circuit generating the local signal by amplifying a given signal and output the local signal to the mixer circuit, wherein
the local amplifier circuit comprises an inductive load including a series circuit in which a amplifier stage load inductor and an amplifier stage load resistor are connected in series.

12. The high-frequency circuit according to claim 2, further comprising:
a local amplifier circuit generating the local signal by amplifying a given signal and output the local signal to the mixer circuit, wherein
the local amplifier circuit comprises an inductive load including a series circuit in which a amplifier stage load inductor and an amplifier stage load resistor are connected in series.

13. The high-frequency circuit according to claim 3, further comprising:
a local amplifier circuit generating the local signal by amplifying a given signal and output the local signal to the mixer circuit, wherein
the local amplifier circuit comprises an inductive load including a series circuit in which a amplifier stage load inductor and an amplifier stage load resistor are connected in series.

14. The high-frequency circuit according to claim 6, further comprising:
a local amplifier circuit generating the local signal by amplifying a given signal and output the local signal to the mixer circuit, wherein
the local amplifier circuit comprises an inductive load including a series circuit in which a amplifier stage load inductor and an amplifier stage load resistor are connected in series.

15. The high-frequency circuit according to claim 7, further comprising:
a local amplifier circuit generating the local signal by amplifying a given signal and output the local signal to the mixer circuit, wherein
the local amplifier circuit comprises an inductive load including a series circuit in which a amplifier stage load inductor and an amplifier stage load resistor are connected in series.

16. The high-frequency circuit according to claim 8, further comprising:
a local amplifier circuit generating the local signal by amplifying a given signal and output the local signal to the mixer circuit, wherein
the local amplifier circuit comprises an inductive load including a series circuit in which a amplifier stage load inductor and an amplifier stage load resistor are connected in series.

17. A high-frequency circuit comprising:
a common-drain transistor receiving a high-frequency signal at its gate terminal and outputting a signal corresponding to the high-frequency signal from its source terminal, and an adjustment circuit inserted between the gate terminal and the drain terminal of the common-drain transistor and including a series circuit in which an adjustment resistor and an adjustment capacitor are connected in series, and
the input impedance of the common-drain transistor is adjusted by at least one of the adjustment resistor and the adjustment capacitor as a parameter.

18. A high-frequency circuit comprising:
a common-drain transistor receiving a high-frequency signal at its gate terminal and outputting a signal corresponding to the high-frequency signal from its source terminal, and an adjustment circuit inserted between the gate terminal of the common-drain transistor and an ac-grounded terminal, and including a series circuit in which an adjustment resistor and an adjustment capacitor are connected in series, and
the input impedance of the common-drain transistor is adjusted by at least one of the adjustment resistor and the adjustment capacitor as a parameter.

19. The high-frequency circuit according to claim 17, wherein
the adjustment resistor and the adjustment capacitor as parameters may be set such that the internal resistance and the internal capacitance defined by the input impedance of the common-drain transistor represent the circuit parameters of a desired band-pass filter.

20. The high-frequency circuit according to claim 18, wherein
the adjustment resistor and the adjustment capacitor as parameters may be set such that the internal resistance and the internal capacitance defined by the input impedance of the common-drain transistor represent the circuit parameters of a desired band-pass filter.
